(19) United States
(12) Patent Application Publication
(10) Pub. No.: US 2026/0010566 A1
(43) Pub. Date: Jan. 8, 2026

(54) AUDIO RECOGNITION METHOD AND APPARATUS, ELECTRONIC DEVICE, AND COMPUTER PROGRAM PRODUCT

(71) Applicant: Beijing Youzhuju Network Technology Co., Ltd., Pinggu District, Beijing (CN)

(72) Inventors: Xingjian DU, Beijing (CN); Huidong LIANG, Beijing (CN); Bilei ZHU, Beijing (CN); Zejun MA, Beijing (CN)

(21) Appl. No.: 18/881,909

(22) PCT Filed: Jun. 30, 2023
(86) PCT No.: PCT/CN2023/105121

§ 371 Date: Jan. 7, 2025

(30) Foreign Application Priority Data
Jul. 13, 2022 (CN) 202210828275.9

(51) Int. Cl. G06F 16/683; G10L 15/06

(52) U.S. Cl. CPC G06F 16/683; G10L 15/063

(57) ABSTRACT

Embodiments of the present disclosure provide an audio recognition method and apparatus, an electronic device, and a computer program product. The method may include obtaining a target feature map of audio data based on a multi-level feature map of the audio data. The method may further include determining a feature representation of the audio data based on the target feature map. In addition, the method may further include determining a recognition result for the audio data at least based on the feature representation. By means of implementing the technical solution of the present disclosure, a determined feature representation has high-resolution position information, thereby optimizing the model performance and improving the user experience.

### CROSS-REFERENCE TO RELATED APPLICATION(S)

The present application claims priority to Chinese Patent Application No. 202210828275.9, filed on Jul. 13, 2022 and entitled “AUDIO RECOGNITION METHOD AND APPARATUS, ELECTRONIC DEVICE, AND COMPUTER PROGRAM PRODUCT”, which is incorporated herein by reference in its entirety.

### FIELD

Embodiments of the present disclosure relate to the field of data processing, and more particularly, to an audio recognition method and apparatus, an electronic device, and a computer program product.

### BACKGROUND

Techniques for intelligently recognizing audio data, such as songs and human voices, are key to research in many fields. Therefore, deep learning-based audio recognition techniques has a wide range of application scenarios in many fields. For example, the current deep learning-based audio recognition techniques often use, for example, convolution operations to implement feature extraction, where extracted features include rich high-level semantic information, but other information is ignored at the same time. There is an urgent need for an audio recognition technique whereby extracted features can include more information.

### SUMMARY

Embodiments of the present disclosure provide an audio recognition solution.

According to a first aspect of the present disclosure, there is provided an audio recognition method. The method may include obtaining a target feature map of audio data based on a multi-level feature map of the audio data. The method may further include determining a feature representation of the audio data based on the target feature map. In addition, the method may further include determining a recognition result for the audio data at least based on the feature representation.

According to a second aspect of the present disclosure, there is provided an audio recognition apparatus. The audio recognition apparatus may include: a target feature map obtaining module configured to obtain a target feature map of audio data based on a multi-level feature map of the audio data; a feature representation determination module configured to determine a feature representation of the audio data based on the target feature map; and a recognition result determination module configured to determine a recognition result for the audio data at least based on the feature representation.

According to a third aspect of the present disclosure, there is provided an electronic device. The electronic device includes: a processor; and a memory coupled to the processor, where the memory has stored therein instructions that, when executed by the processor, cause the electronic device to perform actions including: obtaining a target feature map of audio data based on a multi-level feature map of the audio data; determining a feature representation of the audio data based on the target feature map; and determining a recognition result for the audio data at least based on the feature representation.

According to a fourth aspect of the present disclosure, there is provided a computer program product tangibly stored on a computer-readable medium and including machine-executable instructions that, when executed, cause a machine to perform any step of the method according to the first aspect.

This section is provided to introduce a selection of concepts in a simplified form, which will be further described in the detailed description below. This section is neither intended to identify key features or principal features of the present disclosure, nor to limit the scope of the present disclosure.

### BRIEF DESCRIPTION OF THE DRAWINGS

The above and other objectives, features, and advantages of the present disclosure will become more apparent from the more detailed description of exemplary embodiments of the present disclosure in conjunction with the accompanying drawings. In the exemplary embodiments of the present disclosure, the same or similar reference numerals generally represent the same or similar components. In the accompanying drawings:

FIG. 1 is a schematic diagram of an example environment in which a plurality of embodiments of the present disclosure can be implemented;

FIG. 2 is a schematic diagram of a detailed example environment for training and applying a model according to an embodiment of the present disclosure;

FIG. 3 is a flowchart of a process for audio recognition according to an embodiment of the present disclosure;

FIG. 4 is a schematic diagram of an example environment for determining a feature representation according to an embodiment of the present disclosure;

FIG. 5 is a schematic diagram of a feature map according to an embodiment of the present disclosure;

FIG. 6 is a schematic diagram of a multi-level feature map according to an embodiment of the present disclosure;

FIG. 7 is a schematic diagram of a model training architecture according to an embodiment of the present disclosure;

FIG. 8 is a schematic diagram of an audio recognition apparatus according to an embodiment of the present disclosure; and

FIG. 9 is a schematic block diagram of an example device that may be used to implement the embodiments of the present disclosure.

### DETAILED DESCRIPTION OF EMBODIMENTS

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from a user, prompt information is sent to the user to clearly inform the user that a requested operation will require access to and use of personal information of the user. As such, the user can independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

The principles of the present disclosure will be described below with reference to several example embodiments shown in the accompanying drawings.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, etc. may refer to different objects or the same object. Other explicit and implicit definitions may be included below.

In the embodiments of the present disclosure, the term “data” may refer to real-time data to be subjected to recognition, e.g., an audio clip taken from a song. The audio clip may be subjected to audio recognition by using a trained recognition model. In addition, the term “data” may also refer to data containing labeled information, such as model training data. The labeled information may be, for example, pre-labeled classification information. The term “classification” generally refers to a recognition result for the audio clip, for example, it can be determined, by using a recognition model, whether a frame of audio clip is a certain type of audio, such as chorus. The term “feature representation” generally refers to features extracted from data by using at least part of a deep neural network.

As described above, with the continuous development of computer technologies, the deep neural network has been widely used in all aspects of people's lives. In order to better perform a classification task of audio recognition, a training process of a conventional audio recognition model needs to be optimized. During the training process of the conventional audio recognition model, an extracted feature map has a gradually decreasing resolution as the model becomes deeper. Although the reduced-resolution feature map carries higher-level semantic information, the sacrifice of resolution results in the loss of accurate position information from the feature map. It should be understood that the term “position information” mentioned herein mainly refers to a position of a frame of audio clip in a piece of audio, e.g., a start time or an end time of the frame of audio clip.

According to an embodiment of the present disclosure, there is provided a solution for audio recognition. In the solution, to extract a target feature map used for determining a feature representation, not only is a previous-level feature map closest to the target feature map used, but a feature map obtained through each level or multiple levels of feature extraction is also used, such that a finally obtained target feature map contains both rich semantic information and high-resolution position information, thereby making it possible to solve the above problem and/or other potential problems.

In addition, during model training, the volume and diversity of training data directly determine the model performance. For the training data for audio recognition, insufficient sample volume and/or diversity has a negative impact on the training of the audio recognition model. In view of this, subsequent embodiments of the present disclosure further provide a solution for augmenting the above feature representation determined from the target feature map.

The embodiments of the present disclosure are described in detail below in conjunction with example scenarios. It should be understood that this is merely for the purpose of illustration and is not intended to limit the scope of the present disclosure in any manner.

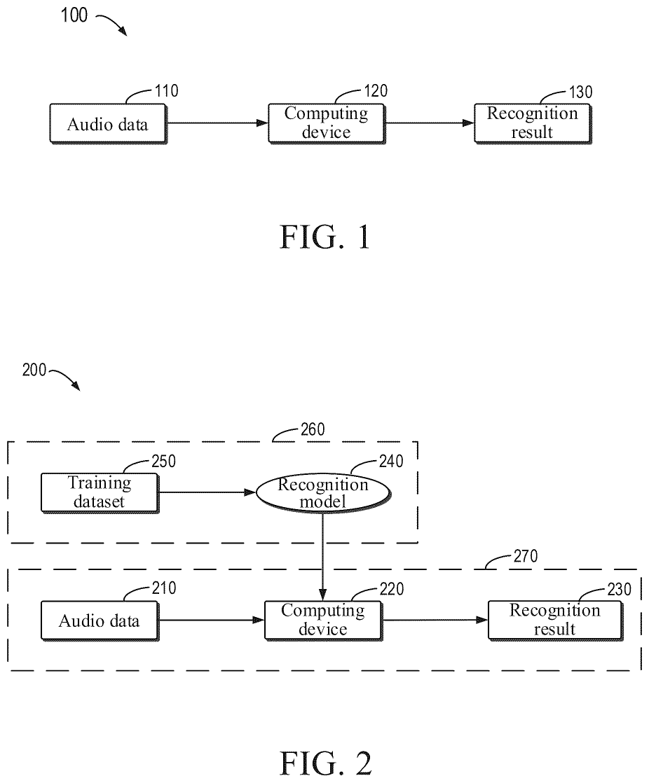

FIG. 1 is a block diagram of an example system 100 for audio recognition according to an embodiment of the present disclosure. It should be understood that the system 100 shown in FIG. 1 is merely an example in which the embodiments of the present disclosure can be implemented, and is not intended to limit the scope of the present disclosure. The embodiments of the present disclosure are equally applicable to other systems or architectures.

As shown in FIG. 1, the system 100 may include a computing device 120. The computing device 120 may be configured to receive audio data 110 and output a recognition result 130 related to the audio data 110. In some embodiments, the audio data 110 is a spectrogram obtained through a constant Q transform or another transform of audio data in time domain.

In some embodiments, the computing device 120 may obtain the audio data 110. In some embodiments, the audio data 110 may be an audio clip to be subjected to recognition. In some other embodiments, the audio data 110 may include a plurality of training samples for training a deep neural network or a machine learning model (also referred to as a target model). The audio data 110 may have corresponding labeled information. Such labeled information may be generated by manual labeling, automatic model labeling, or in other appropriate manners.

In the present disclosure, the target model may be designed to perform an audio recognition task. Examples of the target model include, but are not limited to, various types of deep neural networks (DNNs), convolutional neural networks (CNNs), support vector machines (SVMs), decision trees, random forest models, etc. In implementations of the present disclosure, the target model may also be referred to as a “recognition model”. Hereinafter, the terms “recognition model”, “neural network”, “learning model”, “learning network”, “model”, and “network” are used interchangeably.

In some embodiments, the computing device 120 may include, but is not limited to, a personal computer, a server computer, a handheld or laptop device, a mobile device (such as a mobile phone, a personal digital assistant (PDA), or a media player), a consumer electronic product, a minicomputer, a mainframe computer, a cloud computing resource, etc.

In some embodiments, the recognition result 130 may be set as classification information determined from the audio data 110, e.g., regarding whether the audio data 110, which is an audio clip of a song, falls into a classification of chorus. Alternatively or additionally, the recognition result 130 may also be set as a prediction result that is corrected or updated during model training (the result is compared with a labeled ground-truth result in a subsequent process, to determine a loss function).

It should be understood that the apparatuses and/or units in the apparatuses included in the system 100 are merely exemplary and are not intended to limit the scope of the present disclosure. It should be understood that the system 100 may further include additional apparatuses and/or units not shown. For example, in some embodiments, the computing device 120 of the system 100 may further include a storage unit (not shown) for storing pre-input hyper-parameters and the like, and a trained model.

The training and use of the model in the computing device 120 will be described below with reference to FIG. 2.

FIG. 2 is a schematic diagram of a detailed example environment 200 according to an embodiment of the present disclosure. Similar to FIG. 1, the example environment 200 may include a computing device 220, audio data 210 input into the computing device 220, and a recognition result 230 output from the computing device 220. The difference is that the example environment 200 may generally include a model training system 260 and a model application system 270. As an example, the model training system 260 and/or the model application system 270 may be implemented in the computing device 120 as shown in FIG. 1 or the computing device 220 as shown in FIG. 2. It should be understood that the structure and function of the example environment 200 are described for exemplary purposes only and are not intended to limit the scope of the subject matter described herein. The subject matter described herein may be implemented in different structures and/or functions.

As previously described, the process of processing the input audio data 110 to determine the recognition result 230, such as the classification information about the audio clip, may be divided into two stages: a model training stage and a model application stage. As an example, in the model training stage, the model training system 260 may train a recognition model 240 for performing a corresponding function by using a training dataset 250. It should be understood that the training dataset 250 may be a combination of a plurality of pieces of sample data (as inputs to the recognition model 240) and corresponding labeled supervisory information (or referred to as “labels”, or “truth results”). In the model application stage, the model application system 270 may receive the trained recognition model 240. As such, the recognition model 240 loaded into the computing device 220 of the model application system 270 may determine the recognition result 230 based on the audio data 210.

In other embodiments, the recognition model 240 may be constructed as a learning network. In some embodiments, the learning network may include a plurality of networks, where each of the networks may be a multi-layer neural network that may consist of a large number of neurons. Through the training process, corresponding parameters of the neurons in each network can be determined. The parameters of the neurons in the networks are collectively referred to as parameters of the recognition model 240.

The training process of the recognition model 240 may be performed iteratively, until at least some of the parameters of the recognition model 240 converge or until a predetermined number of iterations is reached, thereby obtaining final model parameters.

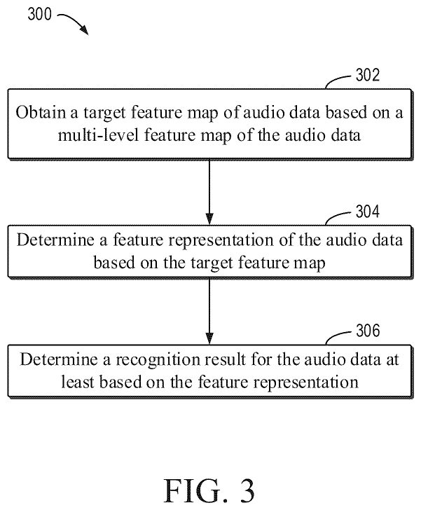

The technical solution described above is for example only, and is not intended to limit the present disclosure. It should be understood that the individual networks may also be arranged in other manners and connection relationships. In order to explain the principle of the above solution more clearly, the process of determining the recognition result 130 from the audio data 110 will be described in more detail below with reference to FIG. 3.

FIG. 3 is a flowchart of a process 300 for audio recognition according to an embodiment of the present disclosure. In certain embodiments, the process 300 may be implemented in the computing device 120 in FIG. 1 and the computing device 220 in FIG. 2. The process 300 for audio recognition according to an embodiment of the present disclosure is now described with reference to FIG. 3. For ease of understanding, the specific instances mentioned in the following description are all exemplary, and are not intended to limit the scope of protection of the present disclosure.

At step 302, the computing device 120 may obtain a target feature map of the audio data 110 based on a multi-level feature map of the audio data 110. Then, at step 304, the computing device 120 may determine a feature representation of the audio data 110 based on the target feature map.

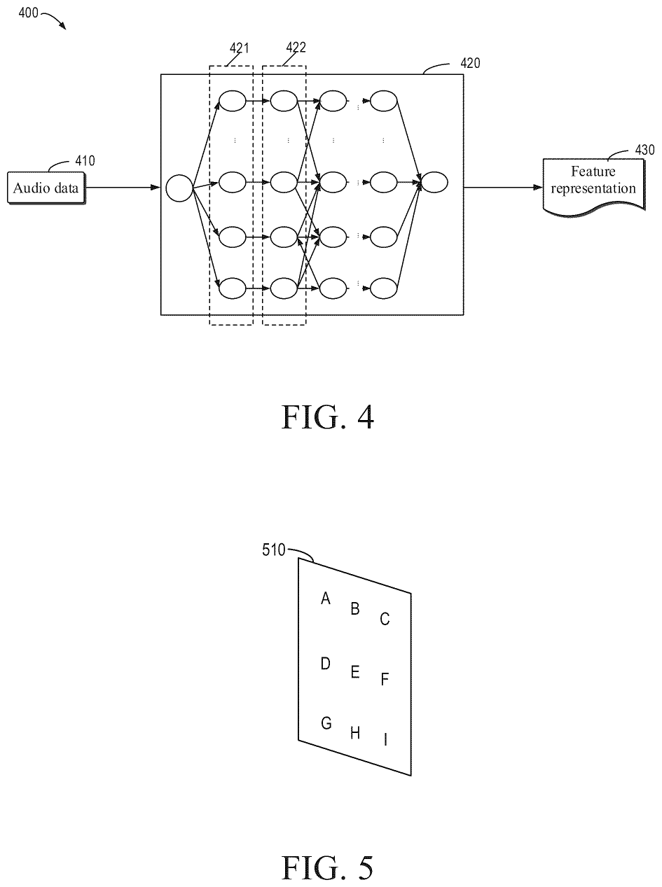

In order to clearly describe the process of determining the “feature representation” mentioned in the present disclosure, the process of feature extraction is now described with reference to FIG. 4. FIG. 4 is a schematic diagram of an example environment 400 for determining a feature representation according to an embodiment of the present disclosure.

As shown in FIG. 4, the example environment 400 includes audio data 410, a feature extraction network 420, and a feature representation 430. It should be understood that the audio data 410 may be the audio data 110 or a fragment of the audio data 110. After the audio data 410 is input into the feature extraction network 420, the feature extraction network 420 performs feature extraction operations on the audio data 410. As an example, the feature extraction network 420 may be a deep neural network as shown in FIG. 4 or a multi-layer feature extractor. As shown, the feature extraction network 420 may include at least a first level of extractors 421 and a second level of extractors 422. It should be understood that the feature extraction network 420 may further include more levels of extractors.

In order to obtain the target feature map, the computing device 120 may obtain a multi-level feature map of the audio data 410 by using, for example, the feature extraction network 420 that includes at least the first level of extractors 421 and the second level of extractors 422 described above. As an example, the first level of extractors 421 and the second level of extractors 422 may be convolutional neural networks, and therefore, the first level of extractors 421 may perform a convolution operation on the audio data 410 to obtain a first-level feature map, and the second level of extractors 422 may perform a convolution operation on the first-level feature map to obtain a second-level feature map.

It should be noted that the convolution operation process is essentially a down-sampling process. As a next-level feature map in the multi-level feature map is extracted from a previous-level feature map, the second-level feature map has a lower resolution than the first-level feature map.

Then, the computing device 120 may perform feature reconstruction at least based on the next-level feature map and the previous-level feature map, to determine the target feature map, and then a feature vector, i.e., the feature representation 430, of the audio data 410 in an abstract space can be obtained. In this way, the resolution of the next-level feature map is improved to that of the previous-level feature map through feature reconstruction, and the feature reconstruction is performed at least based on the next-level feature map and the previous-level feature map, such that both rich semantic information extracted from the next-level feature map and a high resolution in the previous-level feature map are contained, making it easier to locate a particular type of audio clip.

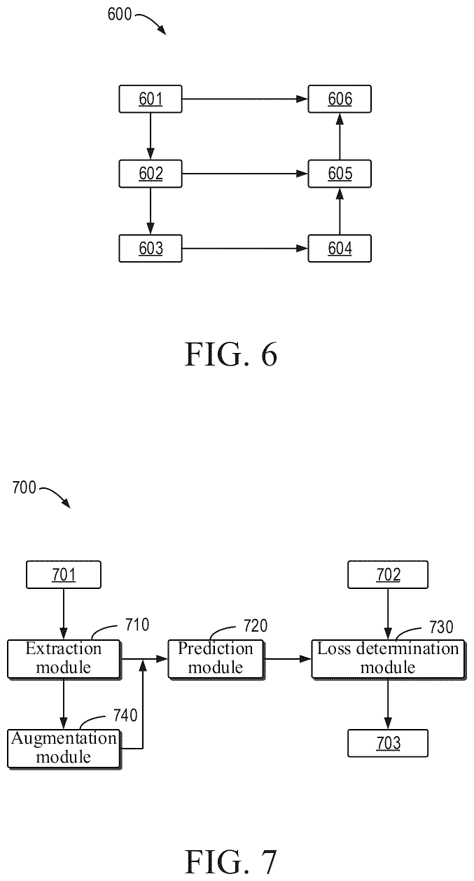

In order to clearly describe the “feature map” mentioned in the present disclosure, an example form of the feature map is now described with reference to FIG. 5. FIG. 5 is a schematic diagram of a feature map 510 according to an embodiment of the present disclosure. As shown in FIG. 5, the feature map 510 may be a set of feature data determined based on the audio data 410, where A to I are specific values of the above feature data. As an example, the feature map 510 may be a 100×100 matrix. After the feature map 510 is subjected to a convolution operation performed by the first level of extractors 421, the feature map 510 is down-sampled to, for example, a 50×50 matrix, and when further subjected to a convolution operation performed by the second level of extractors 422, the feature map 510 is down-sampled to, for example, a 25×25 matrix. For the above process of feature reconstruction, the feature map 510, which is a 25×25 matrix, may be up-sampled to, for example, a 50×50 matrix, and then up-sampled to, for example, a 100×100 matrix. It should be understood that the process of feature reconstruction is not limited thereto. In order to describe in more detail the process of feature extraction and feature reconstruction, an architecture for determining the target feature map is now described with reference to FIG. 6.

FIG. 6 shows a schematic diagram of a multi-level feature map 600 according to an embodiment of the present disclosure. As shown in FIG. 6, the multi-level feature map 600 includes a first-level feature map 601, a second-level feature map 602, a third-level feature map 603, a feature map 604 generated based on the third-level feature map 603, a feature map 605 generated based on the feature map 604 and the second-level feature map 602, and a feature map 606 generated based on the feature map 605 and the first-level feature map 601.

In FIG. 6, the first-level feature map 601 may be extracted from the audio data 410 by the first level of extractors 421 shown in FIG. 4, and the second-level feature map 602 may be extracted from the first-level feature map 601 by the second level of extractors 422 shown in FIG. 4, and then the third-level feature map 603 may be extracted from the second-level feature map 602. It should be understood that the multi-level feature map 600 shown in FIG. 6 may have more levels, and the number of levels is related to a network structure of the model.

As such, the computing device 120 may directly copy values in the third-level feature map 603 into the feature map 604 during feature reconstruction. Then, the computing device 120 may up-sample the feature map 604, i.e., expand the feature map 604 into a spare feature map 605. In other words, the computing device 120 may copy values in the up-sampled feature map 604 into the feature map 605, perform averaging or other operations on values in the second-level feature map 602, which is at the same level as the feature map 605, with values in the feature map 605, and store a calculated result in the feature map 605. Similarly, the computing device 120 may further up-sample the feature map 605, i.e., expand the feature map 605 into a spare feature map 606, perform averaging or other operations on values in the first-level feature map 601, which is at the same level as the feature map 606, with values in the feature map 606, and store a calculated result in the feature map 606, in which case the feature map 606 is the target feature map. In this way, the target feature map contains both rich semantic information and high-resolution position information, thereby optimizing the model performance.

Returning to FIG. 3, at step 306, the computing device 120 may determine the recognition result 130 for the audio data 110 at least based on the feature representation.

In certain embodiments, the audio data 110 is an audio clip of a song. In order to determine the recognition result 130 for the audio data 110, the computing device 120 may determine whether the audio clip falls into the classification of chorus. As such, a chorus part in a song can be recognized automatically. It should be understood that the present disclosure is not limited to recognizing a chorus part in a song, but may also recognize other parts in the song, such as a verse, a transitional sentence, and a bridge, or classifiable parts in other audio data.

In this way, the feature data determined in the above-described embodiments contains richer information, and has more accurate position information than conventional audio recognition modules, thereby improving the model performance.

The above embodiments mainly relate to the application of the recognition model 240, and the training process of the recognition model 240 is described in detail below. During model training, the audio data 110 may be training data or a training dataset, and after the trained model determines the recognition result 130, the computing device 120 may further determine a loss function value of the trained recognition model based on the recognition result 130 and pre-labeled ground-truth results for the training data, to update parameters of the recognition model.

In order to determine the loss function value of the model, the computing device 120 needs to compare a ground-truth label with the recognition result generated in real time. FIG. 7 is a schematic diagram of a model training architecture 700 according to an embodiment of the present disclosure.

As shown in FIG. 7, audio data 701 may be input into an extraction module 710, to determine a feature representation of the audio data 701. Then, the determined feature representation is input into a prediction module 720, to determine a prediction result for the feature representation of the audio data 701. As such, a loss determination module 730 may determine a loss function value 703 of the model based on the determined result and a ground-truth label 702 of the audio data 701.

In certain embodiments, in order to optimize (generalize) the model performance, the computing device 120 may perform data augmentation on the feature representation determined by the extraction module 710. As an example, the computing device 120 may determine, by using an augmentation module 740 in FIG. 7, a distribution of feature representations corresponding to audio clips that fall into or do not fall into a classification of chorus, and then determine sampled feature representations in the distribution as additional feature representations.

In certain embodiments, in order to determine the sampled feature representations as the additional feature representations, the computing device 120 may sample a predetermined number of feature representations in the distribution, and use the predetermined number of feature representations as the additional feature representations. As such, the computing device 120 may input the feature representation determined by the extraction module 710 and the additional feature representations obtained through data augmentation into a fully connected layer of the recognition model, to determine the recognition result or the prediction result. In this way, the present disclosure allows for the augmentation of more training data at the level of feature vector, thereby improving the data volume and diversity of training data.

It should be understood that the feature representation obtained through data augmentation ãᵢ may be generated based on the following formula (1):

$${a}_{i} \sim 𝒩 ( {a}_{i} , λ {\sum }_{yi} ) \qquad ( 1 )$$

where aᵢ is the feature representation, and i is an i^{th} row of features in the feature representation determined by the extraction module 710; yᵢ denotes a labeled category (such as chorus) for an i^{th} frame; Σ_{y}_{ᵢ} denotes a covariance matrix for the category yᵢ, and λ is a hyper-parameter of the model, which may be, for example, set to λ>0.

It should be understood that there is a higher number of sampled feature representations, the computational load for model training may increase significantly. Therefore, the computing device 120 may determine an upper limit of a loss function of the recognition model by setting the number of the sampled feature representations to positive infinity, to determine the loss function value.

Specifically, assuming that the dataset has a size of N and the number of the sampled feature representations is M, a sampling number of the augmented training data is N×(M+1). In certain embodiments, the module may be trained by using a cross-entropy loss function. For the fully connected layer, a weight W corresponding to the category c may be denoted as w_{c}, and an offset b corresponding to the category may be denoted as b_{c}. When M is positive infinity:

$${lim}_{M \to ∞} - \frac{1}{N} {\sum }_{i = 1}^{N} \frac{1}{M} {\sum }_{j = 1}^{M} log ( \frac{exp ( {w}_{{y}_{i}}^{T} {a}_{i}^{( j )} + {b}_{{y}_{i}} )}{{\sum }_{c = 1}^{C} exp ( {w}_{c}^{T} {a}_{i} + {b}_{c} )} ) \qquad ( 2 )$$

Formula (2) is equivalent to the following formula of loss function:

$$ℒ = - \frac{1}{N} {\sum }_{i = 1}^{N} {𝔼}_{{\tilde{a}}_{i}} [ log ( \frac{exp ( {w}_{{y}_{i}}^{T} {\tilde{a}}_{i} + {b}_{{y}_{i}} )}{{\sum }_{c = 1}^{C} exp ( {w}_{c}^{T} {\tilde{a}}_{i} + {b}_{c} )} ) ] \qquad ( 3 )$$

$$= \frac{1}{N} {\sum }_{i = 1}^{N} {𝔼}_{{\tilde{a}}_{i}} [ log ( {\sum }_{c = 1}^{C} exp ( \tilde{ξ} ) ) ] \qquad ( 4 )$$

$$where \tilde{ξ} = {( {w}_{c} - {w}_{{y}_{i}} )}^{T} {\tilde{a}}_{i} + ( {b}_{c} - {b}_{{y}_{i}} ) .$$

By means of the Jensen inequality E[log X]≤log E[X], the upper limit of the loss function [symbol] may be derived, i.e., as in the following formula (5):

$${ℒ}_{upper} = \frac{1}{N} {\sum }_{i = 1}^{N} log ( {𝔼}_{{\tilde{a}}_{i}} [ {\sum }_{c = 1}^{C} exp ( \tilde{ξ} ) ] ) \qquad ( 5 )$$

Finally, the upper limit of the loss function [symbol] may be derived as in the following formula (6):

$${ℒ}_{upper} = - \frac{1}{N} {\sum }_{i = 1}^{N} log ( \frac{exp ( {w}_{{y}_{i}}^{T} {a}_{i} + {b}_{{y}_{i}} )}{{\sum }_{c = 1}^{C} exp ( {w}_{c}^{T} {a}_{i} + {b}_{c} + \frac{1}{2} Δ )} ) \qquad ( 6 )$$

where Δ=λ(w_{c}−w_{y}_{ᵢ})^{T}Σ_{y}_{ᵢ}(w_{c}−w_{y}_{ᵢ}).

In this way, the loss function can be determined without consuming a lot of computing resources as in formula (1), such that the loss function value can be quickly obtained, thereby optimizing the model training.

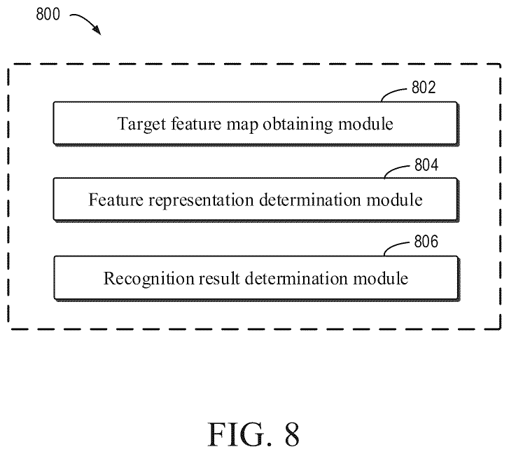

The present disclosure further provides a video recognition apparatus. Specifically, FIG. 8 is a schematic diagram of an audio recognition apparatus 800 according to an embodiment of the present disclosure. As shown in FIG. 8, the audio recognition apparatus 800 may include at least a target feature map obtaining module 802, a feature representation determination module 804, and a recognition result determination module 806. The target feature map obtaining module 802 may obtain a target feature map of audio data based on a multi-level feature map of the audio data. The feature representation determination module 804 may further determine a feature representation of the audio data based on the obtained target feature map. In addition, the recognition result determination module 806 may further determine a recognition result for the audio data at least based on the determined feature representation.

In certain embodiments, the target feature map obtaining module 802 may include a multi-level feature map obtaining sub-module configured to obtain the multi-level feature map of the audio data. It should be understood that a next-level feature map in the multi-level feature map is extracted from a previous-level feature map. The multi-level feature map obtaining sub-module may include a first level of extractors, a second level of extractors, and the like. The first level of extractors may perform a convolution operation on the audio data to obtain a first-level feature map, and the second level of extractors may perform a convolution operation on the first-level feature map to obtain a second-level feature map. In addition, the target feature map obtaining module 802 may further include a target feature map determination sub-module configured to perform feature reconstruction at least based on the next-level feature map and the previous-level feature map, to determine the target feature map.

In certain embodiments, the target feature map determination sub-module may expand the second-level feature map into a first-level spare feature map during feature reconstruction, and determine the target feature map based on the first-level spare feature map and the first-level feature map.

In certain embodiments, the audio data may be training data, and the audio recognition apparatus 800 may further include: a loss function value determination sub-module configured to determine a loss function value of a trained recognition model based on the recognition result and a pre-labeled ground-truth result for the training data, to update parameters of the recognition model.

In certain embodiments, the audio recognition apparatus 800 may further include: a distribution determination module configured to determine a distribution of feature representations corresponding to audio clips that fall into or do not fall into a classification of chorus; and an additional feature representations determination module configured to determine sampled feature representations in the distribution as additional feature representations.

In certain embodiments, the additional feature representations determination module may be configured to sample a predetermined number of feature representations in the distribution, and use the predetermined number of feature representations as the additional feature representations.

In certain embodiments, the loss function value determination sub-module may be configured to determine an upper limit of a loss function of the recognition model by setting the predetermined number to positive infinity, to determine the loss function value.

In certain embodiments, the recognition result determination module 806 may be configured to input the feature representation and the additional feature representations into a fully connected layer of the recognition model, to determine the recognition result.

In certain embodiments, the audio data is an audio clip of a song, and the recognition result determination module 806 may include: a classification module configured to determine that the audio clip falls into or does not fall into the classification of chorus.

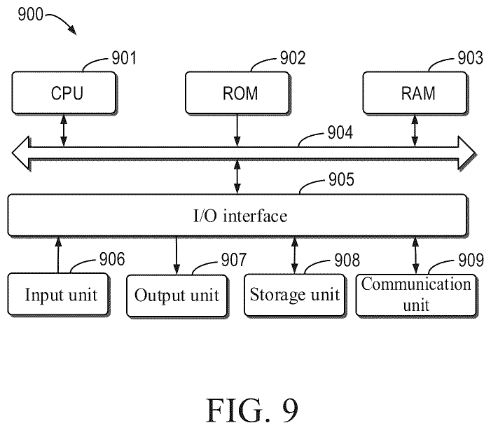

FIG. 9 is a schematic block diagram of an example device 900 that may be used to implement the embodiments of the present disclosure. For example, the computing device 120 as shown in FIG. 1 may be implemented by the device 900. As shown, the device 900 includes a central processing unit (CPU) 901 that may perform a variety of appropriate actions and processing in accordance with computer program instructions stored in a read-only memory (ROM) 902 or computer program instructions loaded from a storage unit 908 into a random access memory (RAM) 903. The RAM 903 may further store various programs and data required for the operation of the device 900. The CPU 901, the ROM 902, and the RAM 903 are connected to each other via a bus 904. An input/output (I/O) interface 905 is also connected to the bus 904.

A number of components in the device 900 are connected to the I/O interface 905, including: an input unit 906, such as a keyboard, or a mouse; an output unit 907, such as a display, or a speaker of various types; a storage unit 908, such as a magnetic disk, or an optical disk; and a communication unit 909, such as a network card, a modem, or a wireless communication transceiver. The communication unit 909 allows the device 900 to exchange information/data with other devices over a computer network such as the Internet and/or various telecommunication networks. It should be understood that in the present disclosure, the output unit 907 may be used to display information on real-time dynamic changes in user satisfaction, information on recognition of key factors for group or individual users of satisfaction, information on an optimization policy, information on evaluation of the effect of implementation of the policy, etc.

The processing unit 901 may be implemented by one or more processing circuits. The processing unit 901 may be configured to perform various processes and processing described above, such as the process 300. For example, in some embodiments, the process 300 may be implemented as a computer software program tangibly embodied in a machine-readable medium, such as the storage unit 908. In some embodiments, some or all of the computer programs may be loaded into and/or installed onto the device 900 via the ROM 902 and/or the communication unit 909. When the computer program is loaded into the RAM 903 and executed by the CPU 901, one or more steps in the process 300 described above may be performed.

### Effect Details

By performing the above embodiments, the performance of the trained model can be significantly improved. In order to verify the model performance, a variety of test datasets are used to test the performance of the trained model and compare the performance of the trained model with that of a number of conventional models.

For a real world computing (RWC) dataset, a convolutional non-negative matrix factorization (CNMF) model has an area under the curve (AUC) score of 0.526, a SCluster model has an AUC score of 0.533, a Highlighter model has an AUC score of 0.804, a Multi2021 model has an AUC score of 0.819, a DeepChorus model has an AUC score of 0.842, and the trained model of the present disclosure has an AUC score of 0.906.

For a salami-pop (SP) dataset, the CNMF model has an AUC score of 0.543, the SCluster model has an AUC score of 0.545, the Highlighter model has an AUC score of 0.703, the Multi2021 model has an AUC score of 0.675, the DeepChorus model has an AUC score of 0.780, and the trained model of the present disclosure has an AUC score of 0.887.

For a salami-live (SL) dataset, the CNMF model has an AUC score of 0.478, the SCluster model has an AUC score of 0.551, the Highlighter model has an AUC score of 0.671, the Multi2021 model has an AUC score of 0.633, the DeepChorus model has an AUC score of 0.765, and the trained model of the present disclosure has an AUC score of 0.831.

For a Di-Chorus (DC) dataset, the CNMF model has an AUC score of 0.488, the SCluster model has an AUC score of 0.568, the Highlighter model has an AUC score of 0.553, the DeepChorus model has an AUC score of 0.811, and the trained model of the present disclosure has an AUC score of 0.872.

In addition, through other experiments, the model of the present disclosure also has a higher F-score than the conventional modules. It can be seen that the audio recognition module trained according to the embodiments of the present disclosure has a significantly improved performance over the conventional models.

The present disclosure may be a system, a method, and/or a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal per se, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages, such as Smalltalk and C++, as well as conventional procedural programming languages, such as “C” language or similar programming languages. The computer-readable program instructions may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to a computer of a user over any type of network, including a local area network (LAN) or a wide area network (WAN), or may be connected to an external computer (for example, connected over the Internet using an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

Various aspects of the present disclosure have been described herein with reference to the flowchart and/or the block diagrams of the method, the apparatus (system), and the computer program product according to the embodiments of the present disclosure. It should be understood that each block of the flowchart and/or the block diagrams and a combination of blocks in the flowchart and/or the block diagrams may be implemented by computer-readable program instructions.

These computer-readable program instructions may be provided to a processing unit of a general-purpose computer, a special-purpose computer, or another programmable data processing apparatus to produce a machine, such that the instructions, when executed by the processing unit of the computer or the another programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowchart and the block diagrams in the accompanying drawings illustrate possible system architectures, functions, and operations of the system, the method, and the computer program product according to a plurality of embodiments of the present disclosure. In this regard, each block in the flowchart or the block diagrams may represent a part of a module, a program segment, or an instruction. The part of the module, the program segment, or the instruction includes one or more executable instructions for implementing a specified logical function. In some alternative implementations, functions marked in the blocks may occur in a sequence different from that marked in the accompanying drawings. For example, two consecutive blocks may actually be executed substantially in parallel, or may sometimes be executed in a reverse order, depending on a function involved. It should also be noted that each block in the block diagram and/or the flowchart, and a combination of the blocks in the block diagram and/or the flowchart may be implemented by a dedicated hardware-based system that executes specified functions or actions, or may be implemented by a combination of dedicated hardware and computer instructions.

According to one or more embodiments of the present disclosure, Example 1 provides an audio recognition method. The method includes: obtaining a target feature map of audio data based on a multi-level feature map of the audio data; determining a feature representation of the audio data based on the target feature map; and determining a recognition result for the audio data at least based on the feature representation.

Example 2 provides the method according to Example 1, where obtaining the target feature map includes: obtaining the multi-level feature map of the audio data, where a next-level feature map in the multi-level feature map is extracted from a previous-level feature map; and performing feature reconstruction at least based on the next-level feature map and the previous-level feature map, to determine the target feature map.

Example 3 provides the method according to Example 2, where the multi-level feature map includes at least: a first-level feature map extracted from the audio data; and a second-level feature map extracted based on the first-level feature map.

Example 4 provides the method according to Example 3, where the feature reconstruction includes at least: expanding the second-level feature map into a first-level spare feature map; and determining the target feature map based on the first-level spare feature map and the first-level feature map.

Example 5 provides the method according to Example 1, where the audio data is training data, and the method further includes: determining a loss function value of a trained recognition model based on the recognition result and a pre-labeled ground-truth result for the training data, to update parameters of the recognition model.

Example 6 provides the method according to Example 5, further including: determining a distribution of feature representations corresponding to audio clips that fall into or do not fall into a classification of chorus; and determining sampled feature representations in the distribution as additional feature representations.

Example 7 provides the method according to Example 6, where determining the sampled feature representations as the additional feature representations includes: sampling a predetermined number of feature representations in the distribution, and using the predetermined number of feature representations as the additional feature representations.

Example 8 provides the method according to Example 7, where determining the loss function value includes: determining an upper limit of a loss function of the recognition model by setting the predetermined number to positive infinity, to determine the loss function value.

Example 9 provides the method according to Example 6, where determining the recognition result at least based on the feature representation includes: inputting the feature representation and the additional feature representations into a fully connected layer of the recognition model, to determine the recognition result.

Example 10 provides the method according to Example 1, where the audio data is an audio clip of a song, and determining the recognition result for the audio data includes: determining that the audio clip falls into a classification of chorus; or determining that the audio clip does not fall into the classification of chorus.

According to one or more embodiments of the present disclosure, Example 11 provides an audio recognition apparatus. The apparatus includes: a target feature map obtaining module configured to obtain a target feature map of audio data based on a multi-level feature map of the audio data; a feature representation determination module configured to determine a feature representation of the audio data based on the target feature map; and a recognition result determination module configured to determine a recognition result for the audio data at least based on the feature representation.

Example 12 provides the audio recognition apparatus according to Example 11, where the target feature map obtaining module includes: a multi-level feature map obtaining sub-module configured to obtain the multi-level feature map of the audio data, where a next-level feature map in the multi-level feature map is extracted from a previous-level feature map; and a target feature map determination sub-module configured to perform feature reconstruction at least based on the next-level feature map and the previous-level feature map, to determine the target feature map.

Example 13 provides the audio recognition apparatus according to Example 12, where the multi-level feature map includes at least: a first-level feature map extracted from the audio data; and a second-level feature map extracted based on the first-level feature map.

Example 14 provides the audio recognition apparatus according to Example 13, where during the feature reconstruction, the target feature map obtaining module may be configured to: expand the second-level feature map into a first-level spare feature map; and determine the target feature map based on the first-level spare feature map and the first-level feature map.

Example 15 provides the audio recognition apparatus according to Example 11, where the audio data is training data, and the audio recognition apparatus further includes: a loss function value determination sub-module configured to determine a loss function value of a trained recognition model based on the recognition result and a pre-labeled ground-truth result for the training data, to update parameters of the recognition model.

Example 16 provides the audio recognition apparatus according to Example 15, further including: a distribution determination module configured to determine a distribution of feature representations corresponding to audio clips that fall into or do not fall into a classification of chorus; and an additional feature representations determination module configured to determine sampled feature representations in the distribution as additional feature representations.

Example 17 provides the audio recognition apparatus according to Example 16, where the additional feature representations determination module is configured to sample a predetermined number of feature representations in the distribution, and use the predetermined number of feature representations as the additional feature representations.

Example 18 provides the audio recognition apparatus according to Example 17, where the loss function value determination sub-module is configured to determine an upper limit of a loss function of the recognition model by setting the predetermined number to positive infinity, to determine the loss function value.

Example 19 provides the audio recognition apparatus according to Example 16, where the recognition result determination module is configured to input the feature representation and the additional feature representations into a fully connected layer of the recognition model, to determine the recognition result.

Example 20 provides the audio recognition apparatus according to Example 11, where the audio data is an audio clip of a song, and the recognition result determination module includes: a classification module configured to determine that the audio clip falls into or does not fall into the classification of chorus.

According to one or more embodiments of the present disclosure, Example 21 provides an electronic device. The electronic device includes: a processor; and a memory coupled to the processor, where the memory has stored therein instructions that, when executed by the processor, cause the electronic device to perform actions including: obtaining a target feature map of audio data based on a multi-level feature map of the audio data; determining a feature representation of the audio data based on the target feature map; and determining a recognition result for the audio data at least based on the feature representation.

Example 22 provides the device according to Example 21, where obtaining the target feature map includes: obtaining the multi-level feature map of the audio data, where a next-level feature map in the multi-level feature map is extracted from a previous-level feature map; and performing feature reconstruction at least based on the next-level feature map and the previous-level feature map, to determine the target feature map.

Example 23 provides the device according to Example 22, where the multi-level feature map includes at least: a first-level feature map extracted from the audio data; and a second-level feature map extracted based on the first-level feature map.

Example 24 provides the device according to Example 23, where the feature reconstruction includes at least: expanding the second-level feature map into a first-level spare feature map; and determining the target feature map based on the first-level spare feature map and the first-level feature map.

Example 25 provides the device according to Example 21, where the audio data is training data, and the method further includes: determining a loss function value of a trained recognition model based on the recognition result and a pre-labeled ground-truth result for the training data, to update parameters of the recognition model.

Example 26 provides the device according to Example 25, further including: determining a distribution of feature representations corresponding to audio clips that fall into or do not fall into a classification of chorus; and determining sampled feature representations in the distribution as additional feature representations.

Example 27 provides the device according to Example 26, where determining the sampled feature representations as the additional feature representations includes: sampling a predetermined number of feature representations in the distribution, and using the predetermined number of feature representations as the additional feature representations.

Example 28 provides the device according to Example 27, where determining the loss function value includes: determining an upper limit of a loss function of the recognition model by setting the predetermined number to positive infinity, to determine the loss function value.

Example 29 provides the device according to Example 26, where determining the recognition result at least based on the feature representation includes: inputting the feature representation and the additional feature representations into a fully connected layer of the recognition model, to determine the recognition result.

Example 30 provides the device according to Example 21, where the audio data is an audio clip of a song, and determining the recognition result for the audio data includes: determining that the audio clip falls into a classification of chorus; or determining that the audio clip does not fall into the classification of chorus.

According to one or more embodiments of the present disclosure, Example 31 provides a computer program product tangibly stored on a computer-readable medium and including machine-executable instructions that, when executed, cause a machine to perform the method according to any one of examples 1 to 10.

Various embodiments of the present disclosure have been described above. The foregoing descriptions are exemplary, not exhaustive, and are not limited to the disclosed embodiments. Many modifications and variations are apparent to a person of ordinary skill in the art without departing from the scope and spirit of the described embodiments. Selection of terms used herein is intended to best explain principles of the embodiments, actual application, or technical improvements to technologies in the market, or to enable another person of ordinary skill in the art to understand the embodiments disclosed herein.

1. An audio recognition method, comprising:
obtaining a target feature map of audio data based on a multi-level feature map of the audio data;
determining a feature representation of the audio data based on the target feature map; and
determining a recognition result for the audio data at least based on the feature representation.

2. The method according to claim 1, wherein obtaining the target feature map comprises:
obtaining the multi-level feature map of the audio data, wherein a next-level feature map in the multi-level feature map is extracted from a previous-level feature map; and
performing feature reconstruction at least based on the next-level feature map and the previous-level feature map, to determine the target feature map.

3. The method according to claim 2, wherein the multi-level feature map comprises at least:
a first-level feature map extracted from the audio data; and
a second-level feature map extracted based on the first-level feature map.

4. The method according to claim 3, wherein the feature reconstruction comprises at least:
expanding the second-level feature map into a first-level spare feature map; and
determining the target feature map based on the first-level spare feature map and the first-level feature map.

5. The method according to claim 1, wherein the audio data is training data, and the method further comprises:
determining a loss function value of a trained recognition model based on the recognition result and a pre-labeled ground-truth result for the training data, to update parameters of the recognition model.

6. The method according to claim 5, further comprising:
determining a distribution of feature representations corresponding to audio clips that fall into or do not fall into a classification of chorus; and
determining sampled feature representations in the distribution as additional feature representations.

7. The method according to claim 6, wherein determining the sampled feature representations as the additional feature representations comprises:
sampling a predetermined number of feature representations in the distribution, and using the predetermined number of feature representations as the additional feature representations.

8. The method according to claim 7, wherein determining the loss function value comprises:
determining an upper limit of a loss function of the recognition model by setting the predetermined number to positive infinity, to determine the loss function value.

9. The method according to claim 6, wherein determining the recognition result at least based on the feature representation comprises:
inputting the feature representation and the additional feature representations into a fully connected layer of the recognition model, to determine the recognition result.

10. The method according to claim 1, wherein the audio data is an audio clip of a song, and determining the recognition result for the audio data comprises:
determining that the audio clip falls into a classification of chorus; or
determining that the audio clip does not fall into the classification of chorus.

11. (canceled)

12. An electronic device, comprising:
a processor; and
a memory coupled to the processor, wherein the memory has stored therein instructions that, when executed by the processor, cause the electronic device to:
obtain a target feature map of audio data based on a multi-level feature map of the audio data;
determine a feature representation of the audio data based on the target feature map; and
determine a recognition result for the audio data at least based on the feature representation.

13. A computer program product tangibly stored on a computer-readable medium and comprising machine-executable instructions that, when executed, cause a machine to:
obtain a target feature map of audio data based on a multi-level feature map of the audio data;
determine a feature representation of the audio data based on the target feature map; and
determine a recognition result for the audio data at least based on the feature representation.

14. The device according to claim 12, wherein the electronic device, when caused to obtain the target feature map, is caused to:
obtain the multi-level feature map of the audio data, wherein a next-level feature map in the multi-level feature map is extracted from a previous-level feature map; and
perform feature reconstruction at least based on the next-level feature map and the previous-level feature map, to determine the target feature map.

15. The device according to claim 14, wherein the multi-level feature map comprises at least:
a first-level feature map extracted from the audio data; and
a second-level feature map extracted based on the first-level feature map.

16. The device according to claim 15, wherein the electronic device, when caused to perform the feature reconstruction, is cause to at least:
expand the second-level feature map into a first-level spare feature map; and
determine the target feature map based on the first-level spare feature map and the first-level feature map.

17. The device according to claim 12, wherein the audio data is training data, and the instruction, when executed by the processor, further cause the electronic device to:
determine a loss function value of a trained recognition model based on the recognition result and a pre-labeled ground-truth result for the training data, to update parameters of the recognition model.

18. The device according to claim 17, wherein the instruction, when executed by the processor, further cause the electronic device to:
determine a distribution of feature representations corresponding to audio clips that fall into or do not fall into a classification of chorus; and
determine sampled feature representations in the distribution as additional feature representations.

19. The device according to claim 18, wherein the electronic device, when caused to determine the sampled feature representations as the additional feature representations, is caused to:
sample a predetermined number of feature representations in the distribution, and use the predetermined number of feature representations as the additional feature representations.

20. The device according to claim 19, wherein the electronic device, when caused to determine the loss function value, is caused to:
determine an upper limit of a loss function of the recognition model by setting the predetermined number to positive infinity, to determine the loss function value.

21. The device according to claim 18, wherein the electronic device, when caused to determine the recognition result at least based on the feature representation, is caused to:
input the feature representation and the additional feature representations into a fully connected layer of the recognition model, to determine the recognition result.
